(19) United States
(12) Patent Application Publication
(10) Pub. No.: US 2014/0246630 A1
(43) Pub. Date: Sep. 4, 2014

(54) CONTINUOUS PROCESS AND CONTINUOUS REACTING APPARATUS FOR SYNTHESIZING SEMICONDUCTOR GASES

(71) Applicant: Duck Joo YANG, Seocho-gu, Seoul (KR)

(72) Inventor: Duck Joo Yang, Seoul (KR)

(21) Appl. No.: 14/349,089

(22) PCT Filed: Oct. 31, 2012
(86) PCT No.: PCT/KR2012/009032

§ 371 Date: Apr. 2, 2014

(30) Foreign Application Priority Data
Oct. 31, 2011 (KR) 10 2011 0112056
Oct. 31, 2012 (KR) 10 2012 0121972

(51) Int. Cl. C01B 6/06; C09D 5/24

(52) U.S. Cl. CPC C01B 6/065; C09D 5/24; C01B 6/06
USPC 252/518.1; 423/645; 422/630; 422/187; 422/111

(57) ABSTRACT

The present invention relates to a continuous process and a continuous reacting apparatus for synthesizing a semiconductor gas including germane (GeH₄) or arsine (AsH₃) gas.

### TECHNICAL FIELD

The present invention relates to a continuous process and a continuous reacting apparatus for synthesizing a semiconductor gas including germane (GeH₄) or arsine (AsH₃) gas.

### BACKGROUND ART

Semiconductor gases, such as Germane (GeH₄), arsine (AsH₃), digermane, trigermane, and diarsine are used with gallane, silane and diborane and other gases to fabricate semiconductor, photovoltaic and optoelectronic devices. There are several known methods for the production of the germane and arsine gases such as a chemical reduction method, an electrochemical method, etc. The gases are typically synthesized using germanium oxide or arsenic oxide such as GeO₂ or As₂O₃ or germanium chloride or arsenic chloride such as GeCl₄ or AsCl₃ as a starting material for the synthesis of germane or arsine. The chemical reduction method includes reacting the oxide or the chloride with a reducing agent such as sodium borohydride (NaBH₄) and lithium aluminum hydride (LiAlH₄). As described above, GeO₂, GeCl₄, As₂O₃ or AsCl₃ has been mainly used as a compound for synthesis of germane and arsine gases. The recent processes for respectively synthesizing germane and arsine gas are of three types: (1) a reaction of oxide dissolved together with a hydride compound in an alkaline medium with an acid medium, (2) a reduction of the germanium (or arsenic) compound dissolved in an alkaline medium, or (3) a reduction of germanium tetrachloride (or arsenic trichloride) dissolved in tetrahydrofuran.

Among the three types, a common chemical reduction method for respectively synthesizing germane and arsine gases is performed as follows:

Germanium oxide or arsine oxide is dissolved in an aqueous alkaline solution;

then, the solution is mixed with an aqueous reducing solution made by dissolving a borohydride compound such as sodium borohydride in water; and

this mixed solution reacts with an inorganic acid or organic acid to produce germane or arsine gas.

The common chemical reduction method has been carried out using a batch reactor.

Prior art literatures on germane synthesis in which a batch process for synthesis of germane gas is used are as follows:
M. Kent Wilson;

“Derivatives of Mono Germane,” Can. J. Chem. 40, 739 (1962), T. N. Srivastava, J. E. Griffiths, and M. Onyszchuk;

“Mono Germane s-Their Synthesis and Properties,” Inorg. Chem. 2, 375 (1963), Griffiths;

“Preparation of Germane,” J. Chem, Soc., 1989 (1959), E. D. Macklen;

“Reactions of Germanium Tetrachloride with Potassium and Sodium Tetrahy-droborates”, Russ. J. Inorg. Chem., 13, 162 (1968), L. M. Antipin;

“The Preparation of the Volatile Hydrides of Groups IV-A and V-A by Means of Aqueous Hydroborate”, J. Amer. Chem. Soc., 83, 335 (1961), W. L. Jolly;

“Hydrides of Germanium,” J. Chem. Soc., 2708 (1962), J. E. Drake and W. L. Jolly; and

“The Preparation of Some Germanium Hydrides”, University of California Lawrence Radiation Laboratory Berkeley, Calif., Contract No. -70405-ENG-48 (1961), John E. Drake.

As given below, there are prior art patent documents on germane synthesis in which a batch process for synthesis of germane is used:

US2010/183500(A1): “Germane gas production from germanium byproducts or impure germanium compounds”;

CN101723326 (A), 2010: “Preparation method of Germane from GeCl₄”;

WO2005/005673(A): “Method for preparing high-purity germanium hydride”;

U.S. Pat. No. 4,668,502 (May 26, 1987): “Method of synthesis of gaseous germane”;

U.S. Pat. No. 3,577,220 (1971): “Germane synthesis from Mg₂Ge/NH₃”;

U.S. Pat. No. 4,656,013 (1985): “Germane synthesis from GeCl₄”;

U.S. Pat. No. 4,824,657 (1981): “Germane synthesis from GeCl₄ with LiH”;

Belgium Pat. No. BE 890356: “Germane synthesis from GeCl₄/NaBH₄ in diglyme”; and

Japanese Patent Laid-open Publication Nos. 10-291804, 62-017004, 60-221322, and 60-221301.

Prior art literatures on arsine synthesis in which a batch process for synthesis of arsine gas is used are as follows:

“Highly Pure Arsenic”, CS 192658 B1 19790917 Czech (1981), Sichrovsky, Dusan, Sichrovska, et al.;

“Preparation of arsine by the reduction of arsenic (III) chloride by sodium tetrahy-droborate”, Zhurnal Neorganicheskoi Khimii (1974), 19(12), 3229-31, Kulakov, S. I., Zaburdyaev, V. S., Sokolov, E. B., Frolov, I. A.;

“The Preparation of the Volatile Hydrides of Groups IV-A and V-A by Means of Aqueous Hydroborate”, J. Amer. Chem. Soc., 83, 335 (1961), W. L. Jolly; and

“The heats of decomposition of arsine and stibine”, J. Phys. Chem., 64, 1334 (1960), S. R. Gunn, W. L. Jolley and L. G. Green.

However, as described above, according to the prior art in which a batch process for synthesis of germane or arsine is used, manufacturing efficiency is low with production of a great amount of byproducts and a manufacturing cost is high due to a bulky batch reactor.

### DISCLOSURE OF INVENTION

### Technical Problem

In view of the foregoing, the present invention provides a process and a device for synthesizing semiconductor gases including germane or arsine, or other digermane, trigermane, and diarsine with high efficiency and low cost while minimizing the amount of byproducts produced during the synthesis of the semiconductor gases including germane or arsine by means of a continuous process of the semiconductor gases including germane or arsine.

### Solution to Problem

In accordance with a first aspect of the present invention, there is provided a continuous process for synthesizing a semiconductor gas, the continuous process comprising:

(a) separating and obtaining a semiconductor gas including a germane gas or an arsine gas produced from a reaction by continuously introducing each of an acidic solution, and a first reactant including a mixture of an alkaline solution containing a germanium compound or an arsenic compound with a reducing agent-containing solution into a first reactor;

(b) supplying a solution into a second reactor, wherein the solution contains a byproduct and/or an unreacted material from which the semiconductor gas including the germane gas or the arsine gas is separated;

(c) producing a second reactant by introducing an alkaline solution into the second reactor to control a pH of the solution containing the byproduct and/or the unreacted material to be in an alkaline range, introducing an oxidizing agent to oxidize the byproduct and/or the unreacted material, and introducing a reducing agent-containing solution; and

(d) additionally obtaining the semiconductor gas including the germane gas or the arsine gas by supplying the second reactant to the first reactor to make a reaction between the second reactant and the acidic solution continuously introduced into the first reactor.

In accordance with a second aspect of the present invention, there is provided a continuous reacting apparatus for synthesizing a semiconductor gas, comprising:

a first reactor connected to a first reactant inlet for introducing a first reactant including a mixture of an alkaline solution containing a germanium compound or an arsenic compound with a reducing agent-containing solution, an acidic solution inlet, a condenser, and a residue collection unit; and

a second reactor connected to the residue collection unit, an alkaline solution inlet, an oxidizing agent inlet, and a reducing agent-containing solution inlet,

wherein the first reactant and an acidic solution are continuously supplied into the first reactor through the first reactant inlet and the acidic solution inlet, respectively;

a semiconductor gas including a germane gas or an arsine gas produced from a reaction between the first reactant and the acidic solution respectively and continuously supplied into the first reactor is separated and obtained via the condenser; and

the residue collection unit collects a byproduct and/or an unreacted material from the first reactor, the byproduct and/or the unreacted material is supplied to the second reactor and reacted with an alkaline solution, an oxidizing agent, and a reducing agent-containing solution in sequence within the second reactor to produce a second reactant, and the second reactant is supplied into the first reactor and reacted with the acidic solution continuously supplied into the first reactor to additionally obtain the semi-conductor gas including the germane gas or the arsine gas.

### Advantageous Effects of Invention

In accordance with the present invention, a semiconductor gas including germane or arsine is synthesized by means of a continuous process, so that unreacted materials produced in the synthesis can be reused in the continuous process. Thus, it is possible to increase manufacturing efficiency of germane or arsine, minimize the amount of byproducts finally produced, and synthesize the semiconductor gas including high purity germane or arsine with low cost.

### BRIEF DESCRIPTION OF DRAWINGS

FIG. 1 is a schematic diagram of a continuous process for synthesizing a semi-conductor gas including germane or arsine in accordance with an illustrative embodiment of the present invention;

FIG. 2 is a schematic diagram of a continuous process for synthesizing a semi-conductor gas including germane or arsine in accordance with an illustrative embodiment of the present invention; and

FIG. 3 is a schematic diagram of a first reactor in accordance with an illustrative embodiment of the present invention.

### BEST MODE FOR CARRYING OUT THE INVENTION

Through the whole document, the term “connected to or “coupled to” that is used to designate a connection or coupling of one element to another element includes both a case that an element is “directly connected or coupled to” another element and a case that an element is “electronically connected or coupled to” another element via still another element.

Through the whole document, the term “on” that is used to designate a position of one element with respect to another element includes both a case that the one element is adjacent to the another element and a case that any other element exists between these two elements.

Further, the term “comprises or includes” and/or “comprising or including” used in the document means that one or more other components, steps, operation and/or existence or addition of elements are not excluded in addition to the described components, steps, operation and/or elements unless context dictates otherwise. The term “about or approximately” or “substantially” are intended to have meanings close to numerical values or ranges specified with an allowable error and intended to prevent accurate or absolute numerical values disclosed for understanding of the present invention from being illegally or unfairly used by any unconscionable third party. Through the whole document, the term “step of” does not mean “step for”.

Through the whole document, the term “combination of” included in Markush type description means mixture or combination of one or more components, steps, operations and/or elements selected from a group consisting of components, steps, operation and/or elements described in Markush type and thereby means that the disclosure includes one or more components, steps, operations and/or elements selected from the Markush group.

In accordance with a first aspect of the present invention, there is provided continuous process for synthesizing a semiconductor gas, the continuous process comprising:

(a) separating and obtaining a semiconductor gas including a germane gas or an arsine gas produced from a reaction by continuously introducing each of an acidic solution, and a first reactant including a mixture of an alkaline solution containing a germanium compound or an arsenic compound with a reducing agent-containing solution into a first reactor;

(b) supplying a solution into a second reactor, wherein the solution contains a byproduct and/or an unreacted material from which the semiconductor gas including the germane gas or the arsine gas is separated;

c) producing a second reactant by introducing an alkaline solution into the second reactor to control a pH of the solution containing the byproduct and/or the unreacted material to be in an alkaline range, introducing an oxidizing agent to oxidize the byproduct and/or the unreacted material, and introducing a reducing agent-containing solution; and

(d) additionally obtaining the semiconductor gas including the germane gas or the arsine gas by supplying the second reactant to the first reactor to make a reaction between the second reactant and the acidic solution continuously introduced into the first reactor.

In the continuous process for synthesizing the semiconductor gas in accordance with the first aspect of the present invention, each step can be performed continuously.

In accordance with an illustrative embodiment, the germanium compound includes germanium oxide or germanium halide, and the arsenic compound includes arsenic oxide or arsenic halide, but it is not limited thereto.

In accordance with an illustrative embodiment, wherein the second reactant includes germanium oxide, germanium halide, arsenic oxide or arsenic halide, but it is not limited thereto.

In accordance with an illustrative embodiment, the semiconductor gas further includes a digermane gas, a trigermane gas or a diarsine gas in addition to the germain or arsine gas, but it is not limited thereto.

In accordance with an illustrative embodiment, the continuous process further comprises separating the germane gas or the arsine gas from the semiconductor gas, but it is not limited thereto.

In accordance with an illustrative embodiment, the step (a) further includes removing impurities in the first reactor by introducing an inert gas into the first reactor prior to the reaction, but it is not limited thereto.

In accordance with an illustrative embodiment, the alkaline solution includes one selected from a group consisting of sodium hydroxide, potassium hydroxide, and combinations thereof, but it is not limited thereto.

In accordance with an illustrative embodiment, the reducing agent includes one selected from a group consisting of sodium borohydride (NaBH₄), lithium borohydride (LiBH₄), sodium aluminum hydride (NaAlH₄), lithium aluminum hydride (LiAlH₄), sodium hydride (NaH), lithium hydride (LiH), magnesium hydride (MgH₂), sodium cyano borohydride (NaCNBH₃), and combinations thereof, but it is not limited thereto.

In accordance with an illustrative embodiment, the acidic solution includes one selected from a group consisting of sulfuric acid, hydrochloric acid, acetic acid, formic acid, and combinations thereof, but it is not limited thereto.

In accordance with an illustrative embodiment, a temperature within the first reactor is in a range of from about 0° C. to about 70° C., but it is not limited thereto.

In accordance with an illustrative embodiment, a mole ratio of the germanium compound or the arsenic compound to the reducing agent in the first reactant is in a range of from about 1:1 to about 1:10, but it is not limited thereto.

In accordance with an illustrative embodiment, the oxidizing agent includes one selected from a group consisting of hydrogen peroxide (H₂O₂), ammonium peroxodisulfate ((NH₄)₂S₂O₈), nitric acid (HNO₃), perchloric acid (HClO₄), hypochlorous acid (HClO), permanganic acid (HMnO₄), chromic acid (H₂CrO₄), lead dioxide (PbO₂), manganese dioxide (MnO₂), copper oxide (CuO), iron chloride, and combinations thereof, but it is not limited thereto.

In accordance with an illustrative embodiment, a pressure within the first reactor is about 2 atm or less, but it is not limited thereto.

In accordance with an illustrative embodiment, a pH of the acidic solution is less than about 7, but it is not limited thereto.

In accordance with an illustrative embodiment, the step (c) includes controlling a pH of the solution containing the byproduct and/or unreacted material to be more than about 7 by introducing the alkaline solution, but it is not limited thereto.

In accordance with an illustrative embodiment, the continuous process further comprises collecting the acidic solution from the second reactor, but it is not limited thereto.

In accordance with an illustrative embodiment, the continuous process further comprises introducing the collected acidic solution to the first reactor, but it is not limited thereto.

In accordance with a second aspect of the present invention, there is provided a continuous reacting apparatus for synthesizing a semiconductor gas, comprising:

a first reactor connected to a first reactant inlet for introducing a first reactant including a mixture of an alkaline solution containing a germanium compound or an arsenic compound with a reducing agent-containing solution, an acidic solution inlet, a condenser, and a residue collection unit; and

a second reactor connected to the residue collection unit, an alkaline solution inlet, an oxidizing agent inlet, and a reducing agent-containing solution inlet,

wherein the first reactant and an acidic solution are continuously supplied into the first reactor through the first reactant inlet and the acidic solution inlet, respectively;

a semiconductor gas including a germane gas or an arsine gas produced from a reaction between the first reactant and the acidic solution respectively and continuously supplied into the first reactor is separated and obtained via the condenser; and

the residue collection unit collects a byproduct and/or an unreacted material from the first reactor, the byproduct and/or the unreacted material is supplied to the second reactor and reacted with an alkaline solution, an oxidizing agent, and a reducing agent-containing solution in sequence within the second reactor to produce a second reactant, and the second reactant is supplied into the first reactor and reacted with the acidic solution continuously supplied into the first reactor to additionally obtain the semi-conductor gas including the germane gas or the arsine gas.

In accordance with an illustrative embodiment, the first reactor is additionally connected to an inert gas inlet, but it is not limited thereto.

In accordance with an illustrative embodiment, the first reactor may be connected to, but not limited to, the condenser that collects the semiconductor gas including germane gas or arsine gas.

In accordance with an illustrative embodiment, the condenser is connected to a molecular sieve-containing column for separating the germane gas or the arsine gas from the semiconductor gas including the germane gas or the arsine gas, but it is not limited thereto. By way of example, if the semiconductor gas passes through the molecular sieve-containing column, the germane or arsine gas can pass through the molecular sieve-containing column and can be condensed and separated by the subsequently connected condenser. If necessary, the germane or arsine gas separated by the condenser can be further separated and purified by a method publicly known in the art.

In accordance with an illustrative embodiment, the semiconductor gas may further include, but is not limited to, digermane, trigermane or diarsine as byproducts in addition to the germane or arsine gas. By way of example, if the semiconductor gas additionally including the digermane, trigermane or diarsine passes through the molecular sieve-containing column, the mixed semiconductor gas including the digermane, trigermane or diarsine in addition to the germane or arsine gas can pass through the molecular sieve-containing column and can be condensed and separated by the subsequently connected condenser. Only the germane or arsine gas can be separated from the mixed semiconductor gas separated by the condenser. If necessary, the germane or arsine gas can be further separated and purified by a method publicly known in the art. Besides, the digermane, trigermane or diarsine can be individually separated and purified from the mixed semiconductor gas from which the germane or arsine gas is separated.

In accordance with an illustrative embodiment, the first reactor includes a first control unit that controls a reaction, but it is not limited thereto.

In accordance with an illustrative embodiment, the residue collection unit includes a second control unit that controls an amount of the byproduct and/or the unreacted material introduced into the second reactor, but it is not limited thereto.

In accordance with an illustrative embodiment, the second reactor may include, but is not limited to, a third control unit that controls the reaction.

Hereinafter, illustrative embodiments of the present invention will be described in detail with reference to the accompanying drawings so that the present invention may be readily implemented by those skilled in the art. However, it is to be noted that the present invention is not limited to the illustrative embodiments but can be embodied in various other ways. In drawings, parts irrelevant to the description are omitted for the simplicity of explanation, and like reference numerals denote like parts through the whole document.

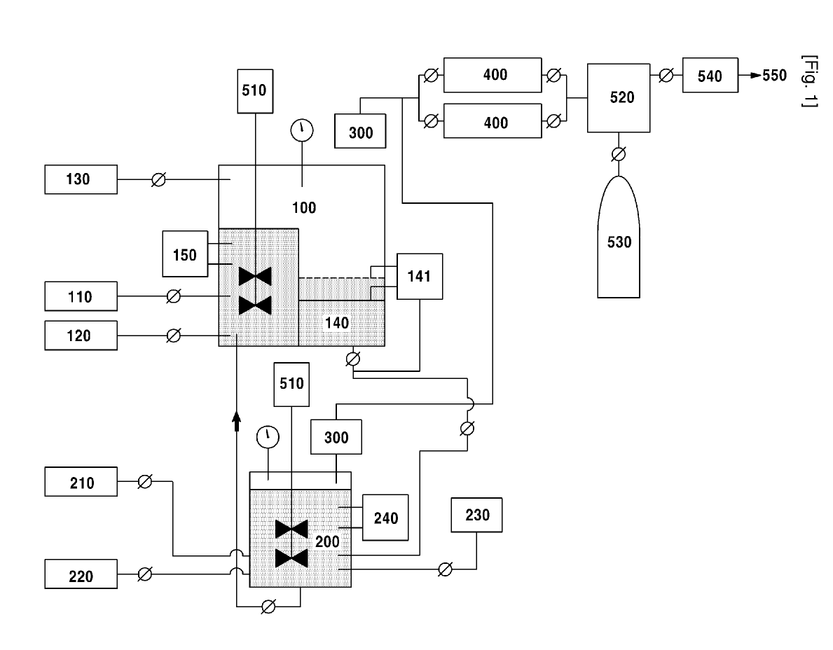

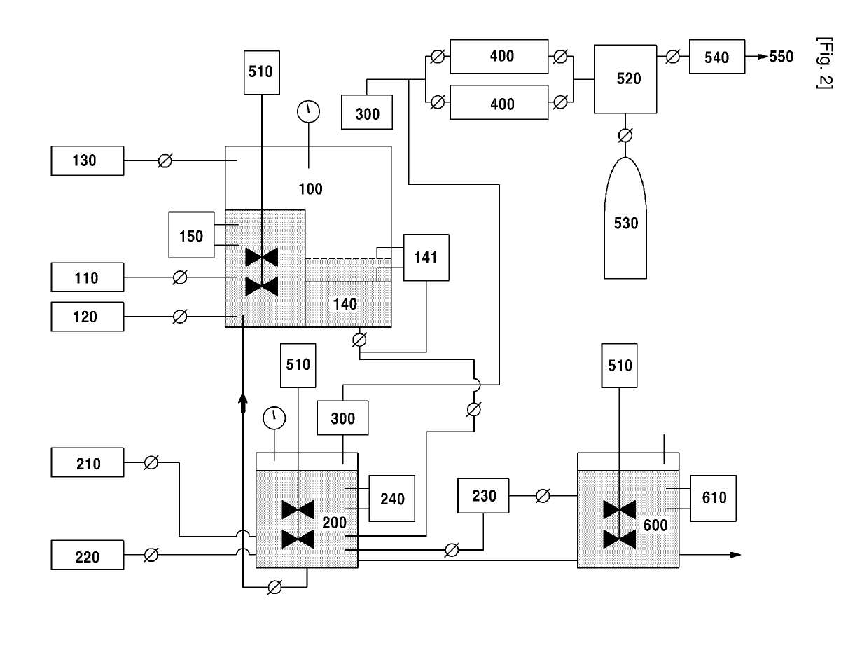

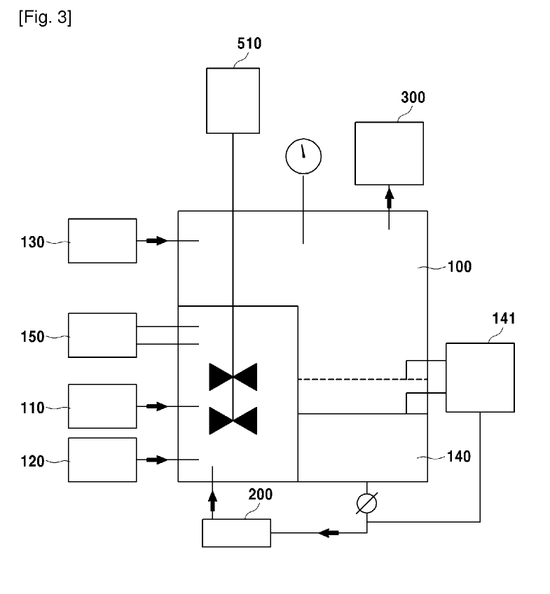

FIGS. 1 and 2 are schematic diagrams of a continuous process for synthesizing a semiconductor gas including germane or arsine in accordance with an illustrative embodiment of the present invention. FIG. 3 is a schematic diagram of a first reactor in accordance with an illustrative embodiment of the present invention.

### <First Illustrative Embodiment> Synthesis of Germane Gas

A first reactant produced by mixing a reducing agent-containing solution with an alkaline solution in which germanium oxide, such as GeO₂, or germanium halide, such as GeF4, GeCl₄, GeBr₄ or GeBr₄, is dissolved is continuously introduced into a first reactor 100 through a first reactant inlet 110. The alkaline solution in which germanium oxide or germanium halide is dissolved may be an aqueous alkaline solution containing one selected from a group consisting of, but not limited to, sodium hydroxide, potassium hydroxide, and combinations thereof, in which the germanium oxide or the germanium halide is dissolved. The alkaline solution has a high purity without impurities such as CO₂, phosphate, nitrate, nitrite, sulfate, and sulfite. By way of example, the alkaline solution may include, but is not limited to, a CO₂-free potassium hydroxide solution or sodium hydroxide solution of about 1 M to about 3 M. The reducing agent-containing solution may be an aqueous solution in which a reducing agent is dissolved. The reducing agent may include one selected from a group consisting of, but not limited to, sodium borohydride (NaBH₄), lithium borohydride (LiBH₄), sodium aluminum hydride (NaAlH₄), lithium aluminum hydride (LiAlH₄), sodium hydride (NaH), lithium hydride (LiH), magnesium hydride (MgH₂), sodium cyano borohydride (NaCNBH₃), and combinations thereof. The reducing agent has a high purity without impurities such as carbonate, phosphate, nitrate, nitrite, sulfate, and sulfite. By way of example, if the reducing agent is sodium borohydride, the reducing agent-containing solution has a mole ratio of the reducing agent to the germanium oxide or the germanium halide in a range of, but not limited to, from about 1:1 to about 1:10. The mole ratio of the reducing agent to the germanium oxide or the germanium halide may be, for example, but not limited to, about 1:1, about 1:2, about 1:3, about 1:4, about 1:5, about 1:6, about 1:7, about 1:8, about 1:9 or about 1:10. By way of example, the germanium oxide or the germanium halide in the mixed solution of the first reactant and the reducing agent can be adjusted to be in a range of, but not limited to, from about 0.1 M to about 0.5 M.

Before the first reactant is introduced into the first reactor 100, an inert gas is introduced into the first reactor 100 through an inert gas inlet 130. Thus, it is possible to remove impurities, such as oxygen (O₂) and/or carbon dioxide (CO₂) within the first reactor 100. By way of example, the inert gas may include, but is not limited to, nitrogen (N₂) or argon (Ar). The inert gas is continuously introduced into the first reactor 100 while a reaction is carried out within the first reactor 100, so that a pressure within the first reactor 100 can be maintained constantly and a product gas can be discharged to the outside of the first reactor 100.

An acidic solution is continuously introduced to the first reactant in the first reactor 100 through an acidic solution inlet 120, and the first reactant reacted with the acidic solution with stirring. By way of example, the acidic solution may include, but is not limited to, an acidic solution selected from a group consisting of sulfuric acid, hydrochloric acid, acetic acid, formic acid, and combinations thereof or an electronic grade acidic solution. The acidic solution may not contain, but is not limited to, phosphoric acid ions, carbonic acid ions, nitric acid ions, nitrous acid ions, and sulfurous acid ions. The acidic solution, such as acetic acid, introduced into the first reactor 100, is introduced to the second reactor 200 and can be collected from the second reactor 200. Colleting the acidic solution from the second reactor 200 is carried out by atmospheric distillation or vacuum distillation, but it is not limited thereto. The collected acidic solution may be introduced to the first reactor again and reused, but it is not limited thereto. A temperature within the first reactor 100 can be adjusted to be in a range of, for example, but not limited to, from about 0° C. to about 70° C., from about 0° C. to about 60° C., from about 0° C. to about 50° C., from about 10° C. to about 70° C., from about 10° C. to about 60° C., from about 10° C. to about 50° C., from about 20° C. to about 50° C., from about 30° C. to about 50° C., or from about 40° C. to about 50° C. The acidic solution may have pH of less than about 7. By way of example, the pH of the acidic solution may be in a range of, but not limited to, from about 0 to less than about 7, from about 0 to about 6, from about 0 to about 5, from about 0 to about 4, from about 0 to about 3, from about 0 to about 2, or from about 0 to about 1, and preferably, from about 0 to about 1. A pH of the mixed solution within the reactor and/or the temperature within the reactor can be monitored and controlled through a first control unit 150 connected to the first reactor 100. The first control unit 150 may include, but is not limited to, a pH sensor and/or a temperature sensor for monitoring.

The first reactant and the acidic solution are respectively and continuously supplied into the first reactor 100 and a reaction is continuously carried out, so that a semi-conductor gas including a germane gas and a hydrogen gas are produced in the first reactor 100. The semiconductor gas including the germane gas may further include a digermane (Ge2H6) gas and a trigermane (Ge₃H₈) gas. When the semiconductor gas and the hydrogen gas are separated and removed from the first reactor 100, a solution containing an unreacted material and a byproduct is continuously produced in the first reactor 100. The solution containing the byproduct and/or the unreacted material is separated by using a residue collection unit 140. The unreacted material may be produced by, but not limited to, oversupply of the first reactant and the acidic solution. By way of example, the unreacted material may include, but is not limited to, GeO₃═. By way of example, the byproduct may include, but is not limited to, a bimolecular compound such as GeH₃(GeH₂)ₓOH. The solution containing the byproduct and/or the unreacted material is introduced into a second reactor 200. The residue collection unit 140 may include, but is not limited to, a second control unit 141 that controls the amount of the byproduct and/or the unreacted material introduced into the second reactor 200. The byproduct and/or the unreacted material are introduced into the second reactor 200 by the second control unit 141 depending on the amount of the byproduct and/or the unreacted material collected in the residue collection unit 140.

The byproduct and/or the unreacted material are converted into a second reactant within the second reactor 200 so as to be introduced into the first reactor 100. In order to convert the byproduct and/or the unreacted material into the second reactant, the second reactor 200 may include, but is not limited to, an oxidizing agent inlet 210 for introducing an oxidizing agent, an alkaline solution inlet 230 for introducing an alkaline solution, and a reducing agent-containing solution inlet 220.

The byproduct and/or the unreacted material supplied from the residue collection unit 140 to the second reactor 200 are mixed and react with an alkaline solution and an oxidizing agent within the second reactor 200. A resultant product is oxidized and mixed with a reducing agent-containing solution to produce the second reactant. The second reactant is supplied again to the first reactor 100 and reacted with the acidic solution continuously supplied into the first reactor 100, and the semiconductor gas including the germane gas and a hydrogen gas may be further produced. The semi-conductor gas including the germane gas may further include a digermane (Ge₂H₆) gas and a trigermane (Ge₃H₈) gas. To be specific, an alkaline solution that does not contain carbon dioxide (CO₂), phosphate, nitrate, nitrite, sulfate or sulfite and an oxidizing agent are introduced into the second reactor 200 to which the solution containing the byproduct and/or the unreacted material is supplied. By introducing the alkaline solution that does not contain the carbon dioxide, phosphate, nitrate, nitrite, sulfate or the sulfite into the second reactor 200, a pH of the solution containing the byproduct and/or the unreacted material in the second reactor 200 can be adjusted to be more than about 7, for example, in a range of, but not limited to, from more than about 7 to about 14, from about 8 to about 14, from about 9 to about 14, from about 10 to about 14, from about 11 to about 14, from about 12 to about 14, from about 13 to about 14, from about 8 to about 13, from about 9 to about 13, from about 10 to about 13, from about 11 to about 13, from about 12 to about 13, and preferably, from about 10 to about 13. The alkaline solution may include one selected from a group consisting of, but not limited to, sodium hydroxide, potassium hydroxide, and combinations thereof. The second reactor 200 may include a third control unit 240, and the third control unit 240 automatically controls the amount of the unreacted material and the byproduct introduced into the second reactor 200, the amount of the oxidizing agent, and the amount and a temperature of the alkaline solution.

Then, the oxidizing agent is supplied to the alkalized solution containing the unreacted material and the byproduct so as to oxidize the byproduct including the bi-molecular compound such as GeH₃(GeH2)ₓOH and convert the byproduct into a material such as germanate (GeO₃═). The oxidizing agent may include one selected from a group consisting of hydrogen peroxide (H₂O₂), ammonium peroxodisulfate ((NH₄)₂S₂O₈), nitric acid (HNO₃), perchloric acid (HClO₄), hypochlorous acid (HClO), permanganic acid (HMnO₄), chromic acid (H₂CrO₄), lead dioxide (PbO₂), manganese dioxide (MnO₂), copper oxide (CuO), iron chloride, and combinations thereof. A concentration of the oxidizing agent may be in a range of, but not limited to, from about 10 wt % to about 20 wt %.

Thereafter, the reducing agent-containing solution is supplied to the alkaline solution and the solution containing the byproduct and/or the unreacted material oxidized with the oxidizing agent and mixed with them so as to produce the second reactant. Then, the second reactant is supplied to the first reactor 100.

To be specific, the second reactant produced in the second reactor 200 is introduced into the first reactor 100. The second reactant is reacted with the acidic solution continuously supplied into the first reactor 100, so that a semiconductor gas including a germane gas and a hydrogen gas are produced. The semiconductor gas including the germane gas may further include a digermane (Ge₂H₆) gas and a trigermane (Ge₃H₈) gas. The unreacted material and the byproduct produced in the first reactor 100 are converted into the second reactant in the second reactor 200, and the second reactant is introduced again into the first reactor 100 so as to produce a germane gas. Thus, a germane gas, a digermane gas, and a trigermane gas can be reproduced continuously. While the second reactant is supplied to the first reactor 100, the first reactant and the acidic solution respectively can be supplied to the first reactor 100 continuously. Thus, the unreacted material and the byproduct can be recirculated continuously, and the germane gas, the digermane gas, and the trigermane gas can be produced continuously.

In accordance with an illustrative embodiment, the first reactor 100 may be connected to a first condenser 300 for collecting steam contained in a product gas. By way of example, a temperature of the first condenser 300 may be controlled in a range of, but not limited to, from about −20° C. to about 0° C. Further, the first condenser 300 connected to the first reactor 100 may be connected to a molecular sieve-containing column 400 and a second condenser 520 in sequence. With this configuration, the semiconductor gas which may include the germane gas, the digermane (Ge₂H₆) gas, and the trigermane (Ge₃H₈) gas produced in the first reactor 100 and the hydrogen gas can pass through the first condenser 300 connected to the first reactor 100 and can be individually separated and purified by the molecular sieve-containing column 400 and the second condenser 520 connected to the first condenser 300. By way of example, a temperature of the second condenser 520 may be controlled by, but not limited to, a temperature of liquid nitrogen.

The separated and purified germane gas is collected by a cylinder 530 connected to the second condenser 520. The separated and purified hydrogen gas is discharged to the outside by a vacuum pump 540 connected to the second condenser 520 or collected to be reused. A method for separating and purifying the germane gas and other semi-conductor gases (e.g.: a digermane (Ge₂H₆) gas, a trigermane (Ge₃H₈) gas, etc.) from the semiconductor gas is not specifically limited. Any method publicly known in the art for separating a gas or a mixed gas can be used.

During the process, a pressure within the first reactor 100 and a pressure within the second reactor 200 can be controlled by using a pressure valve (not illustrated) connected to the vacuum pump 540 or by continuously introducing the inert gas or by using the pressure valve and continuously introducing the inert gas at the same time. The pressures are not specifically limited and can be controlled to a normal pressure, a high pressure or a low pressure. By way of example, the pressures can be controlled to be, for example, but not limited to, about 2 atm or less or equal to or less than about 1 atm. In accordance with an illustrative embodiment of the present invention, the pressures may be, but are not limited to, equal to or less than about 1 atm, from about 100 mmHg to about 760 mmHg, from about 150 mmHg to about 760 mmHg, and from about 200 mmHg to about 760 mmHg.

The solutions used in the reaction during the process circulate the first reactor 100, the residue collection unit 140, and the second reactor 200. When (most of) the unreacted material/byproduct are consumed, the solutions are introduced into a third reactor 600 during the circulation and a pH and/or a temperature of the solutions can be controlled. The third reactor 600 may include a fourth control unit 610 that automatically controls the pH and/or the temperature (normal temperature). After the pH is controlled to about 7 and the temperature is controlled to a normal temperature, when (most of) the unreacted material/byproduct are consumed, the solutions are discharged from the third reactor 600.

In order to synthesize a germane gas, the first reactant is introduced into the first reactor 100, undergoes a reduction-oxidation process, and circulates the first reactor 100. The amount of a byproduct can be minimized through the circulation, environmental pollution caused by a final byproduct can be reduced, manufacturing efficiency of a germane gas can be increased, and a germane gas of a high purity can be produced. A size of the first reactor 100 and a size of the second reactor 200 can be smaller as compared with a size of a batch reactor.

### <Second Illustrative Embodiment> Synthesis of Arsine Gas

A first reactant produced by mixing a reducing agent-containing solution with an alkaline solution in which arsenic oxide, such as As₂O₃, or arsenic halide, such as AsF₃, AsCl₃, AsBr₃ or AsBr₃, is dissolved is continuously introduced into a first reactor 100 through a first reactant inlet 110. The alkaline solution in which arsenic oxide or arsenic halide is dissolved may be an aqueous alkaline solution containing one selected from a group consisting of, but not limited to, sodium hydroxide, potassium hydroxide, and combinations thereof, in which the arsenic oxide or the arsenic halide is dissolved. The alkaline solution has a high purity without impurities such as CO₂, phosphate, nitrate, nitrite, sulfate, and sulfite. By way of example, the alkaline solution may include, but is not limited to, a CO₂-free potassium hydroxide solution or sodium hydroxide solution of about 1 M. The reducing agent-containing solution may be an aqueous solution in which a reducing agent is dissolved. The reducing agent may include one selected from a group consisting of, but not limited to, sodium borohydride (NaBH₄), lithium borohydride (LiBH₄), sodium aluminum hydride (NaAlH₄), lithium aluminum hydride (LiAlH₄), sodium hydride (NaH), lithium hydride (LiH), magnesium hydride (MgH₂), sodium cyano borohydride (NaCNBH₃), and combinations thereof. By way of example, if the reducing agent is sodium borohydride, the reducing agent-containing solution has a mole ratio of the reducing agent to the arsenic oxide or the arsenic halide in a range of, but not limited to, from about 1:1 to about 1:10. The mole ratio of the reducing agent to the arsenic oxide or the arsenic halide may be, for example, but not limited to, about 1:1, about 1:2, about 1:3, about 1:4, about 1:5, about 1:6, about 1:7, about 1:8, about 1:9 or about 1:10. By way of example, the arsenic oxide or the arsenic halide in the mixed solution of the first reactant and the reducing agent can be adjusted to be in a range of, but not limited to, from about 0.1 M to about 0.5 M.

Before the first reactant is introduced into the first reactor 100, an inert gas is introduced into the first reactor 100 through an inert gas inlet 130. Thus, it is possible to remove impurities, such as oxygen (O₂) and/or carbon dioxide (CO₂) within the first reactor 100. By way of example, the inert gas may include, but is not limited to, nitrogen (N₂) or argon (Ar). The inert gas is continuously introduced into the first reactor 100 while a reaction is carried out within the first reactor 100, so that a pressure within the first reactor 100 can be maintained constantly and a product gas can be discharged to the outside of the first reactor 100.

An acidic solution is continuously introduced to the first reactant in the first reactor 100 through an acidic solution inlet 120, and the first reactant reacts with the acidic solution with stirring. By way of example, the acidic solution may include, but is not limited to, an acidic solution selected from a group consisting of sulfuric acid, hydrochloric acid, acetic acid, formic acid, and combinations thereof or an electronic grade acidic solution. The acidic solution may not contain, but is not limited to, phosphoric acid ions, carbonic acid ions, nitric acid ions, nitrous acid ions, and sulfurous acid ions. The acidic solution, such as acetic acid, introduced into the first reactor 100, is introduced to the second reactor 200 and can be collected from the second reactor 200. Colleting the acidic solution from the second reactor 200 is carried out by atmospheric distillation or vacuum distillation, but it is not limited thereto. The collected acidic solution may be introduced to the first reactor again and reused, but it is not limited thereto. A temperature within the first reactor 100 can be adjusted to be in a range of, for example, but not limited to, from about 0° C. to about 70° C., from about 0° C. to about 60° C., from about 0° C. to about 50° C., from about 10° C. to about 70° C., from about 10° C. to about 60° C., or from about 10° C. to about 50° C., from about 20° C. to about 50° C., from about 30° C. to about 50° C., or from about 40° C. to about 50° C. The acidic solution may have a pH of less than about 7. By way of example, the pH of the acidic solution may be in a range of, but not limited to, from about 0 to less than about 7, from about 0 to about 6, from about 0 to about 5, from about 0 to about 4, from about 0 to about 3, from about 0 to about 2, or from about 0 to about 1, and preferably, from about 0 to about 1. A pH of the mixed solution within the reactor and/or the temperature within the reactor can be monitored and controlled through a first control unit 150 connected to the first reactor 100. The first control unit 150 may include, but is not limited to, a pH sensor and/or a temperature sensor for monitoring.

The first reactant and the acidic solution are respectively and continuously supplied into the first reactor 100 and a reaction is continuously carried out, so that a semi-conductor gas including an arsine gas and a hydrogen gas are produced in the first reactor 100. The semiconductor gas including the arsine gas may further include a diarsine (As₂H₆) gas. When the semiconductor gas and the hydrogen gas are separated and removed from the first reactor 100, a solution containing an unreacted material and a byproduct is continuously produced in the first reactor 100. The solution containing the byproduct and/or the unreacted material is separated by using a residue collection unit 140. The unreacted material may be produced by, but not limited to, oversupply of the first reactant and the acidic solution. By way of example, the unreacted material may include, but is not limited to, arsenic oxide. By way of example, the byproduct may include, but is not limited to, a bimolecular compound such as AsH₂—AsHOH. The solution containing the byproduct and/or the unreacted material is introduced into a second reactor 200. The residue collection unit 140 may include, but is not limited to, a second control unit 141 that controls the amount of the byproduct and/or the unreacted material introduced into the second reactor 200. The byproduct and/or the unreacted material are introduced into the second reactor 200 by the second control unit 141 depending on the amount of the byproduct and/or the unreacted material collected in the residue collection unit 140.

The byproduct and/or the unreacted material are converted into a second reactant within the second reactor 200 so as to be introduced into the first reactor 100. In order to convert the byproduct and/or the unreacted material into the second reactant, the second reactor 200 may include, but is not limited to, an oxidizing agent inlet 210 for introducing an oxidizing agent, an alkaline solution inlet 230 for introducing an alkaline solution, and a reducing agent-containing solution inlet 220.

The byproduct and/or the unreacted material supplied from the residue collection unit 140 to the second reactor 200 are mixed and react with an alkaline solution and an oxidizing agent within the second reactor 200. A resultant product is oxidized and mixed with a reducing agent-containing solution to produce the second reactant. The second reactant is supplied again to the first reactor 100 and reacts with the acidic solution continuously supplied into the first reactor 100, and the semiconductor gas including the arsine gas may be further produced. To be specific, an alkaline solution that does not contain carbon dioxide (CO₂) and an oxidizing agent are introduced into the second reactor 200 to which the solution containing the byproduct and/or the unreacted material is supplied. By introducing the alkaline solution that does not contain the carbon dioxide, phosphate, nitrate, nitrite, sulfate or sulfite into the second reactor 200, a pH of the solution containing the byproduct and/or the unreacted material in the second reactor 200 can be adjusted to be more than about 7, for example, in a range of, but not limited to, from more than about 7 to about 14, from about 8 to about 14, from about 9 to about 14, from about 10 to about 14, from about 11 to about 14, from about 12 to about 14, from about 13 to about 14, from about 8 to about 13, from about 9 to about 13, from about 10 to about 13, from about 11 to about 13, from about 12 to about 13, and preferably, from about 10 to about 13. The alkaline solution may include one selected from a group consisting of, but not limited to, sodium hydroxide, potassium hydroxide, and combinations thereof. The second reactor 200 may include a third control unit 240, and the third control unit 240 automatically controls the amount of the unreacted material and the byproduct introduced into the second reactor 200, the amount of the oxidizing agent, and the amount and a temperature of the alkaline solution.

Then, the oxidizing agent is supplied to the alkalized solution containing the unreacted material and the byproduct so as to oxidize the unreacted material including the arsenic oxide or the byproduct including the bimolecular compound such as AsH₂—AsHOH and convert them into a material such as arsenate. The oxidizing agent may include one selected from a group consisting of hydrogen peroxide (H₂O₂), ammonium peroxodisulfate ((NH₄)₂S₂O₈), nitric acid (HNO₃), perchloric acid (HClO₄), hypochlorous acid (HClO), permanganic acid (HMnO₄), chromic acid (H₂CrO₄), lead dioxide (PbO₂), manganese dioxide (MnO₂), copper oxide (CuO), iron chloride, and combinations thereof. A concentration of the oxidizing agent may be in a range of, but not limited to, from about 10 wt % to about 20 wt %.

Thereafter, the reducing agent-containing solution is supplied to the alkaline solution and the solution containing the byproduct and/or the unreacted material oxidized with the oxidizing agent and mixed with them so as to produce the second reactant. Then, the second reactant is supplied to the first reactor 100.

To be specific, the second reactant produced in the second reactor 200 is introduced into the first reactor 100. The second reactant reacts with the acidic solution continuously supplied into the first reactor 100, so that an arsine gas is produced. The unreacted material and the byproduct produced in the first reactor 100 are converted into the second reactant in the second reactor 200, and the second reactant is introduced again into the first reactor 100 so as to produce an arsine gas. Thus, an arsine gas can be reproduced continuously. While the second reactant is supplied to the first reactor 100, the first reactant and the acidic solution respectively can be supplied to the first reactor 100 continuously. Thus, the unreacted material and the byproduct can be recirculated continuously, and the arsine gas can be produced continuously.

In accordance with an illustrative embodiment, the first reactor 100 may be connected to a first condenser 300 for collecting steam contained in a product gas. By way of example, a temperature of the first condenser 300 may be controlled in a range of, but not limited to, from about −20° C. to about 0° C. Further, the first condenser 300 connected to the first reactor 100 may be connected to a molecular sieve-containing column 400 and a second condenser 520 in sequence. With this configuration, a semi-conductor gas which may include the germane gas and the diarsine gas produced in the first reator 100 and the hydrogen gas can pass through the first condenser 300 connected to the first reactor 100 and can be individually separated and purified by the molecular sieve-containing column 400 and the second condenser 520 connected to the first condenser 300. By way of example, a temperature of the second condenser 520 may be controlled by, but not limited to, a temperature of liquid nitrogen.

The separated and purified semiconductor gas is collected by a cylinder 530 connected to the second condenser 520. The separated and purified hydrogen gas is discharged to the outside by a vacuum pump 540 connected to the second condenser 520 or collected to be reused. The semiconductor gas may further include a diarsine gas in addition to the arsine gas as a main product. A method for separating and purifying the arsine gas and the diarsine gas from the semiconductor gas is not specifically limited. Any method publicly known in the art for separating a gas or a mixed gas can be used.

During the process, a pressure within the first reactor 100 and a pressure within the second reactor 200 can be controlled by using a pressure valve (not illustrated) connected to the vacuum pump 540 or by continuously introducing the inert gas or by using the pressure valve and continuously introducing the inert gas at the same time. The pressures are not specifically limited and can be controlled to a normal pressure, a high pressure or a low pressure. By way of example, the pressures can be controlled to be, for example, but not limited to, about 2 atm or less or equal to or less than about 1 atm. In accordance with an illustrative embodiment of the present invention, the pressures may be, but are not limited to, equal to or less than about 1 atm, from about 100 mmHg to about 760 mmHg, from about 150 mmHg to about 760 mmHg, and from about 200 mmHg to about 760 mmHg.

The solutions used in the reaction during the process circulate the first reactor 100, the residue collection unit 140, and the second reactor 200. When (most of) the unreacted material/byproduct are consumed, the solutions are introduced into a third reactor 600 during the circulation and a pH and/or a temperature of the solutions can be controlled. The third reactor 600 may include a fourth control unit 610 that automatically controls the pH and/or the temperature (normal temperature). After the pH is controlled to about 7 and the temperature is controlled to a normal temperature, when (most of) the unreacted material/byproduct are consumed, the solutions are discharged from the third reactor 600.

In order to synthesize an arsine gas, the first reactant is introduced into the first reactor 100, undergoes a reduction-oxidation process, and circulates the first reactor 100. The amount of a byproduct can be minimized through the circulation, environmental pollution caused by a final byproduct can be reduced, manufacturing efficiency of an arsine gas can be increased, and an arsine gas of a high purity can be produced. A size of the first reactor 100 and a size of the second reactor 200 can be smaller as compared with a size of a batch reactor.

FIG. 3 is a schematic diagram of a first reactor 100 in accordance with an illustrative embodiment of the present invention. The first reactor 100 is connected to a first reactant inlet 110 and a first reactant is introduced into the first reactor 100 through the first reactant inlet 110. A diameter and a length of a passageway for introducing the first reactant is adjusted so as to fill the empty first reactor 100 with the solution containing the first reactant within about 5 minutes to about 10 minutes. The first reactant and an acidic solution are mixed in the first reactor 100 by a stirrer 510 and react with each other, so that a germane gas or an arsine gas is synthesized. The stirrer 510 may include, but is not limited to, an over-head stirrer having numerous pedals and/or a stirrer using ultrasonication. The first reactor 100 may include a first control unit 150 for monitoring and controlling a pH, a temperature, and a pressure. The first reactor 100 may include a residue collection unit 140 for collecting an unreacted material and a byproduct and a second control unit 141 for controlling the amount of the unreacted material and/ or the byproduct. The second control unit 141 monitors and controls the amount, a pH, a temperature, and a pressure of the unreacted material and/or the byproduct collected by the residue collection unit 140. If the unreacted material and/ or the byproduct collected by the residue collection unit 140 exceed a certain level, the second control unit 141 controls the unreacted material and/ or the byproduct so as to be separated and discharged to a second reactor 200.

The above description of the present invention is provided for the purpose of illustration, and it would be understood by those skilled in the art that various changes and modifications may be made without changing technical conception and essential features of the present invention. Thus, it is clear that the above-described illustrative embodiments are illustrative in all aspects and do not limit the present invention. For example, each component described to be of a single type can be implemented in a distributed manner. Likewise, components described to be distributed can be implemented in a combined manner.

The scope of the present invention is defined by the following claims rather than by the detailed description of the illustrative embodiment. It shall be understood that all modifications and embodiments conceived from the meaning and scope of the claims and their equivalents are included in the scope of the present invention.

[Explanation of Codes]

100: First reactor

110: First reactant inlet

120: Acidic solution inlet

130: Inert gas inlet

140: Residue collection unit

141: Second control unit

150: First control unit

200: Second reactor

210: Oxidizing agent inlet

220: Reducing agent-containing solution inlet

230: Alkaline solution inlet

240: Third control unit

300: First condenser

400: Molecular sieve-containing column

510: Stirrer

520: Second condenser

530: Cylinder

540: Vacuum pump

550: Hydrogen gas/nitrogen gas vent

600: Third reactor

610: Fourth control unit

1. A continuous process for synthesizing a semiconductor gas, the continuous process comprising:
(a) separating and obtaining a semiconductor gas including a germane gas or an arsine gas produced from a reaction by continuously introducing each of an acidic solution, and a first reactant including a mixture of an alkaline solution containing a germanium compound or an arsenic compound with a reducing agent-containing solution into a first reactor; (b) supplying a solution into a second reactor, wherein the solution contains a byproduct and/or an unreacted material from which the semiconductor gas including the germane gas or the arsine gas is separated;
(c) producing a second reactant by introducing an alkaline solution into the second reactor to control a pH of the solution containing the byproduct and/or the unreacted material to be in an alkaline range, introducing an oxidizing agent to oxidize the byproduct and/or the unreacted material, and introducing a reducing agent-containing solution; and
(d) additionally obtaining the semiconductor gas including the germane gas or the arsine gas by supplying the second reactant to the first reactor to make a reaction between the second reactant and the acidic solution continuously introduced into the first reactor.

2. The continuous process of claim 1,
wherein the germanium compound includes germanium oxide or germanium halide, and the arsenic compound includes arsenic oxide or arsenic halide.

3. The continuous process of claim 1,
wherein the second reactant includes germanium oxide, germanium halide, arsenic oxide or arsenic halide.

4. The continuous process of claim 1,
wherein the semiconductor gas further includes a digermane gas, a trigermane gas or a diarsine gas.

5. The continuous process of claim 4, further comprising:
separating the germane gas or the arsine gas from the semiconductor gas.

6. The continuous process of claim 1,
wherein the step (a) further includes:
removing impurities in the first reactor by introducing an inert gas into the first reactor prior to the reaction.

7. The continuous process of claim 1,
wherein the alkaline solution includes one selected from a group consisting of sodium hydroxide, potassium hydroxide, and combinations thereof.

8. The continuous process of claim 1,
wherein the reducing agent includes one selected from a group consisting of sodium borohydride (NaBH₄), lithium borohydride (LiBH₄), sodium aluminum hydride (NaAlH₄), lithium aluminum hydride (LiAlH₄), sodium hydride (NaH), lithium hydride (LiH), magnesium hydride (MgH₂), sodium cyano borohydride (NaCNBH₃), and combinations thereof.

9. The continuous process of claim 1,
wherein the acidic solution includes one selected from a group consisting of sulfuric acid, hydrochloric acid, acetic acid, formic acid, and combinations thereof.

10. The continuous process of claim 1,
wherein a temperature within the first reactor is in a range of from about 0° C. to about 70° C.

11. The continuous process of claim 1,
wherein a mole ratio of the germanium compound or the arsenic compound to the reducing agent in the first reactant is in a range of from about 1:1 to about 1:10.

12. The continuous process of claim 1,
wherein the oxidizing agent includes one selected from a group consisting of hydrogen peroxide (H₂O₂), ammonium peroxodisulfate ((NH₄)₂S₂O₈), nitric acid (HNO₃), perchloric acid (HClO₄), hypochlorous acid (HClO), permanganic acid (HMnO₄), chromic acid (H₂CrO₄), lead dioxide (PbO₂), manganese dioxide (MnO₂), copper oxide (CuO), iron chloride, and combinations thereof.

13. The continuous process of claim 1,
wherein a pressure within the first reactor is about 2 atm or less.

14. The continuous process of claim 1,
wherein a pH of the acidic solution is less than about 7.

15. The continuous process of claim 1,
wherein the step (c) includes:
controlling a pH of the solution containing the byproduct and/or unreacted material to be more than about 7 by introducing the alkaline solution.

16. The continuous process of claim 1, further comprising:
collecting the acidic solution from the second reactor.

17. The continuous process of claim 16, further comprising:
introducing the collected acidic solution to the first reactor.

18. A continuous reacting apparatus for synthesizing a semiconductor gas, comprising:
a first reactor connected to a first reactant inlet for introducing a first reactant including a mixture of an alkaline solution containing a germanium compound or an arsenic compound with a reducing agent-containing solution, an acidic solution inlet, a condenser, and a residue collection unit; and
a second reactor connected to the residue collection unit, an alkaline solution inlet, an oxidizing agent inlet, and a reducing agent-containing solution inlet,
wherein the first reactant and an acidic solution are continuously supplied into the first reactor through the first reactant inlet and the acidic solution inlet, respectively;
a semiconductor gas including a germane gas or an arsine gas produced from a reaction between the first reactant and the acidic solution respectively and continuously supplied into the first reactor is separated and obtained via the condenser; and
the residue collection unit collects a byproduct and/or an unreacted material from the first reactor, the byproduct and/or the unreacted material is supplied to the second reactor and reacted with an alkaline solution, an oxidizing agent, and a reducing agent-containing solution in sequence within the second reactor to produce a second reactant, and the second reactant is supplied into the first reactor and reacted with the acidic solution continuously supplied into the first reactor to additionally obtain the semiconductor gas including the germane gas or the arsine gas.

19. The continuous reacting apparatus of claim 18,
wherein the first reactor is additionally connected to an inert gas inlet.

20. The continuous reacting apparatus of claim 18,
wherein the condenser is connected to a molecular sieve-containing column for separating the germane gas or the arsine gas from the semi-conductor gas including the germane gas or the arsine gas.

21. The continuous reacting apparatus of claim 18,
wherein the first reactor includes a first control unit that controls a reaction.

22. The continuous reacting apparatus of claim 18,
wherein the residue collection unit includes a second control unit that controls an amount of the byproduct and/or the unreacted material introduced into the second reactor.
